(19) United States
(12) Patent Application Publication
(10) Pub. No.: US 2022/0052748 A1
(43) Pub. Date: Feb. 17, 2022

(54) UPLINK TRANSMISSION METHOD, TERMINAL, AND NETWORK SIDE DEVICE

(71) Applicant: VIVO MOBILE COMMUNICATION CO.,LTD., Guangdong (CN)

(72) Inventors: Yu YANG, Guangdong (CN); Zhi Lu, Guangdong (CN)

(21) Appl. No.: 17/504,321

(22) Filed: Oct. 18, 2021

Related U.S. Application Data
(63) Continuation of application No. PCT/CN2020/086110, filed on Apr. 22, 2020.

(30) Foreign Application Priority Data
Apr. 26, 2019 (CN) 201910345796.7

(51) Int. Cl. H04B 7/06; H04W 76/19; H04W 74/08; H04W 74/00; H04L 1/18; H04L 5/00

(52) U.S. Cl. CPC H04B 7/0695; H04W 76/19; H04W 74/0841; H04L 5/0053; H04W 74/004; H04L 1/1812; H04W 74/0866

(57) ABSTRACT

An uplink transmission method includes: sending second uplink information based on a priority of first uplink information in a case that a resource collision occurs between first uplink transmission and second uplink transmission, where the first uplink information includes information transmitted in the first uplink transmission and information transmitted in the second uplink transmission, the first uplink information includes BFRQ information, and the second uplink information includes a part or all of the first uplink information.

### CROSS-REFERENCE TO RELATED APPLICATIONS

This application is a Bypass Continuation Application of PCT/CN2020/086110, filed on Apr. 22, 2020, which claims priority to Chinese Patent Application No. 201910345796.7, filed on Apr. 26, 2019, which are incorporated herein by reference in their entirety.

### TECHNICAL FIELD

The present disclosure relates to the field of communications technologies, and in particular, to an uplink transmission method, a terminal, and a network side device.

### BACKGROUND

In a high-frequency band communications system, because a wavelength of a wireless signal is relatively short, a case that the signal is blocked or the like tends to occur during propagation, and consequently signal propagation is interrupted. In view of this, a beam failure recovery (BFR) mechanism is introduced. However, in a beam failure recovery process, a resource collision may occur between uplink transmission used to transmit beam failure recovery request (BFRQ) information and other uplink transmission. Currently, in this resource collision scenario, there is no corresponding solution for performing uplink transmission, thereby affecting communication reliability of the communications system.

### SUMMARY

Embodiments of the present disclosure provide an uplink transmission method, a terminal, and a network side device.

According to a first aspect, an embodiment of the present disclosure provides an uplink transmission method, applied to a terminal. The method includes:

sending second uplink information based on a priority of first uplink information in a case that a resource collision occurs between first uplink transmission and second uplink transmission, where

the first uplink information includes information transmitted in the first uplink transmission and information transmitted in the second uplink transmission,

the first uplink information includes beam failure recovery request BFRQ information, and the second uplink information includes a part or all of the first uplink information.

According to a second aspect, an embodiment of the present disclosure provides an uplink transmission method, applied to a network side device. The method includes:

receiving first uplink information sent by a terminal, where the first uplink information is information sent by the terminal based on a priority of second uplink information in a case that a resource collision occurs between first uplink transmission and second uplink transmission, the first uplink information includes a part or all of the second uplink information, the second uplink information includes information transmitted in the first uplink transmission and information transmitted in the second uplink transmission, and the second uplink information includes beam failure recovery request BFRQ information; and

determining information content of the first uplink information based on the priority of the second uplink information.

According to a third aspect, an embodiment of the present disclosure provides a terminal, including:

a sending module, configured to send second uplink information based on a priority of first uplink information in a case that a resource collision occurs between first uplink transmission and second uplink transmission, where

the first uplink information includes information transmitted in the first uplink transmission and information transmitted in the second uplink transmission, the first uplink information includes beam failure recovery request BFRQ information, and the second uplink information includes a part or all of the first uplink information.

According to a fourth aspect, an embodiment of the present disclosure provides a network side device, including:

a receiving module, configured to receive first uplink information sent by a terminal, where the first uplink information is information sent by the terminal based on a priority of second uplink information in a case that a resource collision occurs between first uplink transmission and second uplink transmission, the first uplink information includes a part or all of the second uplink information, the second uplink information includes information transmitted in the first uplink transmission and information transmitted in the second uplink transmission, and the second uplink information includes beam failure recovery request BFRQ information; and

a determining module, configured to determine information content of the first uplink information based on the priority of the second uplink information.

According to a fifth aspect, an embodiment of the present disclosure provides a terminal, including: a memory, a processor, and a computer program that is stored in the memory and executable on the processor. When the computer program is executed by the processor, the steps of the uplink transmission method provided in the first aspect in the embodiments of the present disclosure are implemented.

According to a sixth aspect, an embodiment of the present disclosure provides a network side device, including: a memory, a processor, and a computer program that is stored in the memory and executable on the processor. When the computer program is executed by the processor, the steps of the uplink transmission method provided in the second aspect in the embodiments of the present disclosure are implemented.

According to a seventh aspect, an embodiment of the present disclosure further provides a non-transitory computer-readable storage medium. The non-transitory computer-readable storage medium stores a computer program, and when the computer program is executed by a processor, the steps of the uplink transmission method provided in the first aspect in the embodiments of the present disclosure are implemented or the steps of the uplink transmission method provided in the second aspect in the embodiments of the present disclosure are implemented.

### BRIEF DESCRIPTION OF DRAWINGS

To describe the technical solutions in the embodiments of the present disclosure more clearly, the following briefly describes the accompanying drawings required for describing the embodiments of the present disclosures. Apparently, the accompanying drawings in the following description show merely some embodiments of the present disclosure, and a person of ordinary skill in the art may still derive other drawings from these accompanying drawings.

FIG. 1 is a system diagram of uplink transmission system according to an embodiment of the present disclosure;

FIG. 2 is a flowchart of an uplink transmission method according to an embodiment of the present disclosure;

FIG. 3 is a flowchart of another uplink transmission method according to an embodiment of the present disclosure;

FIG. 4 is a flowchart of another uplink transmission method according to an embodiment of the present disclosure;

FIG. 5 is a structural diagram of a terminal according to an embodiment of the present disclosure;

FIG. 6 is a structural diagram of another terminal according to an embodiment of the present disclosure;

FIG. 7 is a structural diagram of a network side device according to an embodiment of the present disclosure;

FIG. 8 is a schematic diagram a hardware structure of another terminal according to an embodiment of the present disclosure; and

FIG. 9 is schematic diagram of a hardware structure of another network side device according to an embodiment of the present disclosure.

### DESCRIPTION OF EMBODIMENTS

The following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure shall fall within the protection scope of the present disclosure.

The term “include” and any other variants in the specification and claims of this application mean to cover the non-exclusive inclusion, for example, a process, method, system, product, or device that includes a list of steps or units is not necessarily limited to those steps or units, but may include other steps or units not expressly listed or inherent to such a process, method, product, or device. In addition, in the specification and claims, “and/or” is used to indicate at least one of connected objects. For example, A and/or B represents the following three cases: Only A is included, only B is included, and both A and B exist.

In the embodiments of the present disclosure, the word such as “exemplary” or “example” is used to represent giving an example, an illustration, or a description. Any embodiment or design scheme described as an “exemplary” or “example” in the embodiments of the present disclosure should not be explained as being more preferred or having more advantages than another embodiment or design scheme. Exactly, use of the term “example” or “for example” is intended to present a concept in a specific manner.

The embodiments of the present disclosure are described below with reference to the accompanying drawings. The embodiments of the present disclosure may be applied to a wireless communications system. The wireless communications system may be a 5G system, or an evolved Long Term Evolution (eLTE) system, or a subsequent evolved communications system.

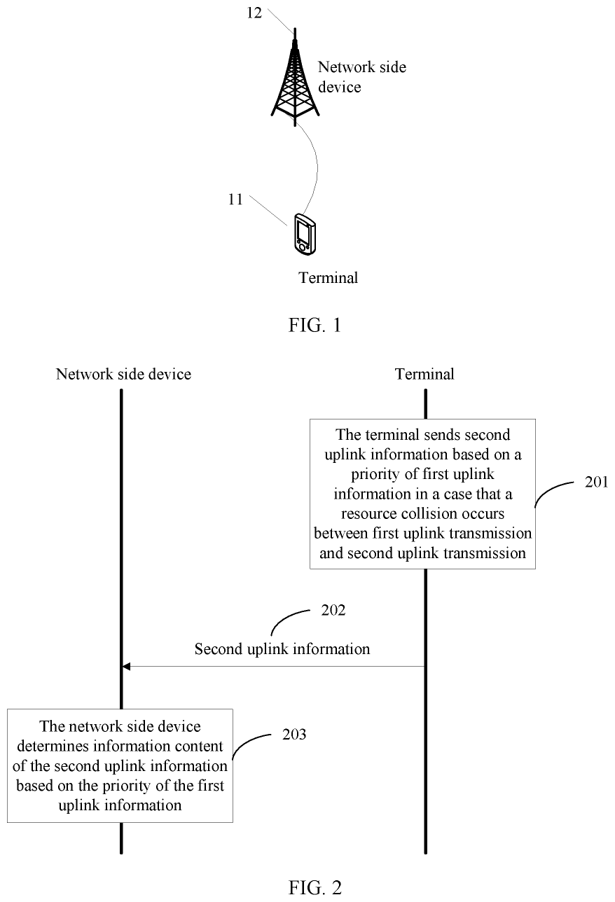

FIG. 1 is a structural diagram of uplink transmission system according to an embodiment of the present disclosure. As shown in FIG. 1, the system includes a terminal 11 and a network side device 12. The terminal 11 may be a mobile communications device such as a mobile phone, a tablet personal computer, a laptop computer, a personal digital assistant (PDA), a mobile Internet device (MID), or a wearable device. It should be noted that a specific type of the terminal 11 is not limited in this embodiment of the present disclosure. The network side device 12 may be a 5G network side device (for example, a gNB or a 5G NR NB), or may be a 4G network side device (for example, an eNB), or may be a 3G network side device (for example, an NB), or a network side device in a subsequent evolved communications system. It should be noted that a specific type of the network side device 12 is not limited in this embodiment of the present disclosure.

Before the technical solutions in the embodiments of the present disclosure are described in detail, a beam failure recovery mechanism is briefly described.

In a high-frequency band communications system, because a wavelength of a wireless signal is relatively short, a case that the signal is blocked or the like tends to occur during propagation, and consequently signal propagation is interrupted. In this case, the beam failure recovery mechanism is introduced, and the mechanism includes the following four aspects.

1. Beam failure detection. A terminal measures a beam failure detection reference signal at a physical layer, and determines, based on a measurement result, whether a beam failure instance occurs. If it is detected that hypothetical PDCCH BLERs of all control beams meet a preset condition (exceed a preset threshold), it is determined that a beam failure instance occurs. The physical layer of the terminal reports an indication to a higher layer (for example, a Medium Access Control (MAC) layer) of the terminal, and the reporting process is periodic. On the contrary, if the physical layer of the terminal determines that no beam failure instance occurs, the terminal does not send an indication to the higher layer. The higher layer of the terminal counts, by using a counter, a quantity of times of indications reported by the physical layer. When a maximum quantity of times configured by a network is reached, the terminal declares that a beam failure event occurs.

2. New beam identification (New candidate beam identification). The physical layer of the terminal measures a beam identification reference signal (beam identification RS), and searches for a new candidate beam. The new beam may be determined after a beam failure event occurs, or may be determined before a beam failure event occurs. The terminal selects the new beam based on whether a measurement result meets a preset condition (for example, measurement quality of the beam identification RS exceeds a preset layer 1-reference signal received power (L1-RSRP threshold)).

3. Beam failure recovery request transmission. The higher layer (for example, a MAC layer) of the terminal determines a PRACH resource or sequence based on the selected candidate beam. If the terminal determines that a trigger condition of a BFRQ is met, the terminal sends the foregoing BFRQ to a base station on a contention-free PRACH. The terminal needs to send the BFRQ based on a quantity of times and/or a timer of sending a request configured by the network. The contention-free PRACH resource herein and other PRACH resources (for example, PRACH resources used for initial access) may be FDM or CDM, where PRACH preambles of the CDM need to have a same sequence design.

4. The terminal monitors a response of a network side device to a beam failure recovery request (UE monitors gNB response for beam failure recovery request). After receiving the BFRQ, the network side device sends a response on a dedicated PDCCH in a control resource set (Control Resource Set-Beam Failure Recovery, CORESET-BFR) used for beam failure recovery, where the response carries a cell radio network temporary identifier (Cell RNTI, C-RNTI), and may further include a handover to the new candidate beam, a beam search restart, or another indication. If the beam failure recovery fails, the physical layer of the terminal sends an indication to the higher layer of the terminal, so that the higher layer determines a subsequent radio link failure process.

It should be noted that a beam may also be referred to as a spatial filter, a spatial domain transmission filter, or the like. Beam information may be referred to as transmission configuration indicator state (TCI state) information, quasi co-location (QCL) information, spatial relation information, or the like.

In the beam failure recovery process, a resource collision may occur between uplink transmission used to transmit BFRQ information and other uplink transmission. Currently, in this resource collision scenario, there is no corresponding solution for the terminal to perform uplink transmission, thereby affecting communication reliability of the communications system.

In view of this, an embodiment of the present disclosure provides uplink transmission system shown in FIG. 1, and provides an uplink transmission method applied to the uplink transmission system. As shown in FIG. 2, the uplink transmission method is applied to the uplink transmission system, and the method includes the following steps.

Step 201: A terminal sends second uplink information based on a priority of first uplink information in a case that a resource collision occurs between first uplink transmission and second uplink transmission.

The first uplink information includes information transmitted in the first uplink transmission and information transmitted in the second uplink transmission, the first uplink information includes BFRQ information, and the second uplink information includes a part or all of the first uplink information.

Uplink transmission generally refers to an uplink channel or an uplink reference signal.

Step 202: A network side device receives the second uplink information sent by the terminal.

Step 203: The network side device determines information content of the second uplink information based on the priority of the first uplink information.

In this embodiment of the present disclosure, the priority of the first uplink information may be configured by the network side device, or may be agreed upon according to a protocol. This is not limited in this embodiment of the present disclosure.

A related implementation of the priority of the first uplink information and a related implementation of sending the second uplink information by the terminal are described in detail below.

In this embodiment of the present disclosure, in a beam failure recovery process, when a resource collision occurs between uplink transmission used to transmit BFRQ information and other uplink transmission, a terminal may determine, based on a priority of first uplink information, second uplink information that needs to be sent, and send the second uplink information to a network side device. The network side device may distinguish, based on the priority of the first uplink information, the second uplink information received by the network side device. In this way, because the priority of the uplink information is considered, the terminal can preferentially send uplink information with a higher priority, thereby ensuring proper uplink transmission, ensuring communication reliability of a communications system, and improving communication performance of the communications system.

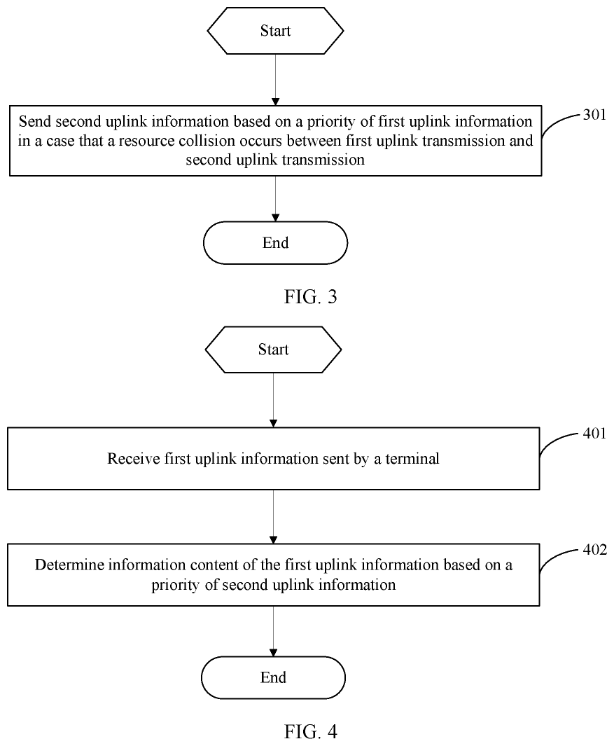

FIG. 3 is a flowchart of an uplink transmission method according to an embodiment of the present disclosure. As shown in FIG. 3, the uplink transmission method is applied to a terminal, and the method includes the following steps.

Step 301: Send second uplink information based on a priority of first uplink information in a case that a resource collision occurs between first uplink transmission and second uplink transmission.

The first uplink information includes information transmitted in the first uplink transmission and information transmitted in the second uplink transmission, the first uplink information includes BFRQ information, and the second uplink information includes a part or all of the first uplink information.

Uplink transmission generally refers to an uplink channel or an uplink reference signal. The resource collision may be understood as resource overlapping or a resource conflict. That a resource collision occurs between first uplink transmission and second uplink transmission may be understood as that a channel resource of the information transmitted in the first uplink transmission and a channel resource of the information transmitted in the second uplink transmission totally or partially overlap in time domain and/or frequency domain.

The BFRQ information may include at least one of a scheduling request (SR) used to indicate a beam failure event, new beam information, or index information of a cell in which a beam failure occurs.

In addition to the BFRQ information, the first uplink information may include a scheduling request (SR), a hybrid automatic repeat request acknowledgement (HARQ-ACK), a channel state information (CSI) report, uplink data information, a sounding reference signal (SRS), and information transmitted on a physical random access channel (PRACH) in the related art.

To distinguish between the SR used to indicate the beam failure event and the SR in the related art, the SR used to indicate the beam failure event may be referred to as a dedicated SR, and the SR in the related art may be referred to as an existing SR.

In this embodiment of the present disclosure, a priority of each piece of information in the first uplink information may be determined from a perspective of a plurality of dimensions, for example, a dimension of each piece of information content, a dimension of a cell corresponding to each piece of information, and a dimension of an uplink channel corresponding to each piece of information. Each dimension may be understood as a priority relationship, that is, the priority of each piece of information in the first uplink information may be determined based on at least one of a plurality of priority relationships of each piece of information.

Optionally, a priority relationship is a priority relationship of each piece of information content. In this case, a priority relationship of each piece of information content may be preconfigured or agreed upon, so that the priority of each piece of information in the first uplink information can be determined based on the priority relationship of each piece of information content.

Another priority relationship is a priority relationship of a cell corresponding to each piece of information. In this case, the priority relationship of the cell corresponding to each piece of information may be preconfigured or agreed upon, so that the priority of each piece of information in the first uplink information can be determined based on the priority relationship of the cell corresponding to each piece of information.

It should be noted that a cell corresponding to the BFRQ information is a cell in which a beam failure event occurs, and a cell corresponding to the HARQ-ACK is a cell for which a retransmission response is performed on downlink data.

Another priority relationship is a priority relationship of an uplink channel corresponding to each piece of information. In this case, the priority relationship of the uplink channel corresponding to each piece of information may be preconfigured or agreed upon, so that the priority of each piece of information in the first uplink information can be determined based on the priority relationship of the uplink channel corresponding to each piece of information.

It should be noted that the uplink channel corresponding to each piece of information is an uplink channel on which each piece of information is transmitted.

The priority relationship of each piece of information content may be configured by a network side device, or may be agreed upon according to a protocol.

For example, the first uplink information includes at least one of the BFRQ information, the existing SR, the HARQ-ACK, the CSI report, the uplink data information, the SRS, or the information transmitted on the PRACH, and the priority relationship of each piece of information content in the first uplink information may include but is not limited to at least one of the following:

a priority of the BFRQ information is a highest priority;

the priority of the BFRQ information is higher than a priority of the HARQ-ACK;

the priority of the BFRQ information is higher than a priority of the existing SR;

the priority of the BFRQ information is higher than a priority of the CSI report;

the priority of the BFRQ information is higher than a priority of the SRS;

the priority of the BFRQ information is higher than a priority of the information transmitted on the PRACH;

the priority of the BFRQ information is higher than a priority of the uplink data information;

the priority of the BFRQ information is lower than the priority of the HARQ-ACK;

the priority of the BFRQ information is lower than the priority of the existing SR;

the priority of the BFRQ information is lower than the priority of the SRS; or

the priority of the BFRQ information is lower than the priority of the information transmitted on the PRACH.

A priority of a periodic SRS or a semi-persistent SRS is generally lower than the priority of the BFRQ information. A priority of an aperiodic SRS may be higher than the priority of the BFRQ information, or may be lower than the priority of the BFRQ information.

In addition, for a priority relationship between the HARQ-ACK, the existing SR, the information transmitted on the PRACH, the CSI report, the uplink data information, and the like, refer to the conclusion in the related art. For example, the priorities of the CSI report and the uplink data information are generally lower than the priorities of the HARQ-ACK, the existing SR, and the information transmitted on the PRACH, and the priority of the CSI report may be higher than or lower than the priority of the uplink data information. A priority relationship of each piece of information content cannot be exhaustively described. Therefore, details are not described.

The priority relationship of the cell corresponding to each piece of information may be configured by the network side device, or may be agreed upon according to the protocol.

A priority of information corresponding to a primary cell (Pcell) is generally higher than a priority of information corresponding to a secondary cell (Scell) in the first uplink information.

The priority relationship of the uplink channel corresponding to each piece of information may be configured by the network side device, or may be agreed upon according to the protocol.

For example, a priority of information transmitted on an aperiodic uplink channel is higher than a priority of information transmitted on a periodic uplink channel in the first uplink information. For another example, the priority of the information transmitted on the aperiodic uplink channel is higher than a priority of information transmitted on a semi-persistent uplink channel in the first uplink information.

The following uses an example in which the first uplink information includes a dedicated PUCCH (dedicated SR) for Pcell, a dedicated PUCCH (dedicated SR) for Scell, an HARQ-ACK/existing SR for Pcell, an HARQ-ACK/existing SR for Scell, a CSI report for Pcell, and a CSI report for Scell to describe the priority of each piece of information. A dedicated physical uplink control channel (PUCCH) is a PUCCH used to transmit the BFRQ information.

For example, priorities of all pieces of information in descending order are the dedicated PUCCH (dedicated SR) for Pcell, the dedicated PUCCH (dedicated SR) for Scell, the HARQ-ACK/existing SR for Pcell, the HARQ-ACK/existing SR for Scell, and the CSI report.

For another example, priorities of all pieces of information in descending order are the dedicated PUCCH (dedicated SR) for Pcell, the HARQ-ACK/existing SR for Pcell, the dedicated PUCCH (dedicated SR) for Scell, the HARQ-ACK/existing SR for Scell, and the CSI report.

For another example, priorities of all pieces of information in descending order are the HARQ-ACK/existing SR for Pcell, the HARQ-ACK/existing SR for Scell, the dedicated PUCCH (dedicated SR) for Pcell, the dedicated PUCCH (dedicated SR) for Scell, and the CSI report.

For another example, priorities of all pieces of information in descending order are the HARQ-ACK/existing SR for Pcell, the dedicated PUCCH (dedicated SR) for Pcell, the HARQ-ACK/existing SR for Scell, the dedicated PUCCH (dedicated SR) for Scell, and the CSI report.

In this embodiment of the present disclosure, the priority of each piece of information in the first uplink information is determined from the perspective of the plurality of dimensions, so that the priority of each piece of information is determined more rationally, thereby ensuring rationality of uplink transmission, ensuring communication reliability of a communications system, and improving communication performance of the communications system.

In this embodiment of the present disclosure, the terminal may end the second uplink information based on the priority of the first uplink information through dropping (drop) or multiplexing. For the dropping, the terminal may send information with a highest priority in the first uplink information, and drop other information in the first uplink information. For the multiplexing, the terminal may send at least two pieces of information in the first uplink information through multiplexing in descending order of priorities.

The terminal may drop or send conflicting uplink information through multiplexing based on the priority of the first uplink information, a payload size of the first uplink information, a payload size of a channel resource, and the like. For example, the terminal determines, based on information such as the priority of the first uplink information, the payload size of the first uplink information, and the payload size of the channel resource, uplink information content that can be carried on the channel resource, and sends the uplink information on the channel resource. The terminal drops uplink information with a lower priority that cannot be carried.

Certainly, the terminal may also drop or send the conflicting uplink information through multiplexing based on a network side configuration or a protocol agreement.

In this embodiment of the present disclosure, the information transmitted in the first uplink transmission may include the BFRQ information, and the information transmitted in the second uplink transmission may also include the BFRQ information. For ease of understanding and description, in this embodiment of the present disclosure, it is assumed that the information transmitted in the first uplink transmission includes the BFRQ information.

In this embodiment of the present disclosure, an uplink channel corresponding to the first uplink transmission may be a PUCCH used to transmit the BFRQ information, or may be a physical uplink shared channel (PUSCH) used to transmit the BFRQ information; and an uplink channel corresponding to the second uplink transmission may be a PUCCH, a PUSCH, or a PRACH. The information transmitted in the second uplink transmission may also be an SRS. To better understand this embodiment of the present disclosure, the following uses a plurality of scenarios as examples to separately describe how the terminal sends uplink information.

Scenario 1: An uplink channel corresponding to the first uplink transmission is a first physical uplink control channel PUCCH used to transmit the BFRQ information, and an uplink channel corresponding to the second uplink transmission is a second PUCCH used to transmit uplink control information (UCI).

A part or all of the BFRQ information and the UCI is sent by using the first PUCCH or the second PUCCH based on the priority of the first uplink information, where

the UCI includes at least one of the SR (that is, the existing SR), the HARQ-ACK, or the CSI report.

In this scenario, the first PUCCH and the second PUCCH may be located in a same cell, may be located in a same cell group, or may be located in different cell groups. This is not limited in this embodiment of the present disclosure.

Optionally, the UCI includes the HARQ-ACK; and

the sending second uplink information based on a priority of first uplink information includes:

sending the BFRQ information and the HARQ-ACK through multiplexing by using the first PUCCH or the second PUCCH in descending order of priorities.

Generally, both the priority of the BFRQ information and the priority of the HARQ-ACK are relatively high. Therefore, the first PUCCH or the second PUCCH are used to simultaneously send the BFRQ information and the HARQ-ACK through multiplexing, to ensure preferential transmission of the BFRQ information and the HARQ-ACK, thereby ensuring communication reliability of the communications system and improving communication performance of the communications system. Assuming that the BFRQ information includes the dedicated SR, and the priority of the BFRQ information is higher than the priority of the HARQ-ACK, the BFRQ information and the HARQ-ACK may be sent on the first PUCCH or the second PUCCH through multiplexing in a bit arrangement order Odedicated SR+OHARQ-ACK. Alternatively, assuming that the BFRQ information includes the dedicated SR, and the priority of the BFRQ information is lower than the priority of the HARQ-ACK, the BFRQ information and the HARQ-ACK may be sent on the first PUCCH or the second PUCCH through multiplexing in a bit arrangement order OHARQ-ACK+Odedicated SR.

Optionally, the sending the BFRQ information and the HARQ-ACK through multiplexing by using the first PUCCH or the second PUCCH includes at least one of the following:

extending a resource length of the first PUCCH, and sending the BFRQ information and the HARQ-ACK through multiplexing by using the first PUCCH;

extending a resource length of the second PUCCH, and sending the BFRQ information and the HARQ-ACK through multiplexing by using the second PUCCH;

changing a code rate of the BFRQ information and/or the HARQ-ACK, and sending the BFRQ information and the HARQ-ACK through multiplexing by using the first PUCCH;

changing a code rate of the BFRQ information and/or the HARQ-ACK, and sending the BFRQ information and the HARQ-ACK through multiplexing by using the second PUCCH; or

sending the BFRQ information and the HARQ-ACK through multiplexing by using a PUCCH that has a correspondence with a cell index in the first PUCCH and the second PUCCH.

For a manner of extending a resource length of a PUCCH, the BFRQ information may be reported through explicit sending.

The BFRQ information generally includes the dedicated SR, and a length of the HARQ-ACK is generally greater than a length of the dedicated SR. Therefore, the resource length of the second PUCCH may be preferentially extended, that is, the resource length of the second PUCCH is extended to carry the dedicated SR and the HARQ-ACK, and the dedicated SR and the HARQ-ACK are sent through multiplexing by using the second PUCCH. When the BFRQ information further includes other information, such as new beam information or cell index information, these pieces of information may be subsequently sent by using another channel.

Certainly, even if the length of the HARQ-ACK is greater than the length of the dedicated SR, the resource length of the first PUCCH may also be extended, that is, the resource length of the first PUCCH is extended to carry the dedicated SR and the HARQ-ACK, and the dedicated SR and the HARQ-ACK are sent through multiplexing by using the first PUCCH. When the BFRQ information further includes other information, such as new beam information or cell index information, these pieces of information may be subsequently sent by using another channel.

In addition to the foregoing manner of extending a resource length of a PUCCH, the resource length of the PUCCH may not be extended, and a correspondence between a resource index of the first PUCCH or the second PUCCH and a cell index is established. In this way, when a beam failure event occurs in a cell, the BFRQ information and the HARQ-ACK may be simultaneously sent on a resource index of a PUCCH that has a correspondence with a cell index. This reporting manner of the BFRQ information may be understood as an implicit manner. It should be noted that when the BFRQ information further includes other information, such as cell index information, because there is a correspondence between a PUCCH resource index and a cell index, the cell index information does not need to be explicitly reported.

In addition to the foregoing manner of extending a resource length of a PUCCH, the resource length of the PUCCH may not be extended, but a code rate of the BFRQ information and/or the HARQ-ACK is changed. Optionally, the code rate of the BFRQ information and/or the HARQ-ACK is increased, to shorten a length of the BFRQ information and/or the HARQ-ACK after encoding, so that the first PUCCH or the second PUCCH can carry the BFRQ information and the HARQ-ACK. Certainly, the code rate of the BFRQ information and/or the HARQ-ACK may not be changed, but a resource block (RB) resource is configured for the first PUCCH or the second PUCCH.

When the BFRQ information and the HARQ-ACK are encoded, the BFRQ information (for example, the dedicated SR) may be placed in front of the HARQ-ACK, or the BFRQ information is placed behind the HARQ-ACK, and then the BFRQ information and the HARQ-ACK are jointly encoded. Alternatively, the BFRQ information and the HARQ-ACK may be separately encoded, and then encoded BFRQ information is placed in front of an encoded HARQ-ACK, or the encoded BFRQ information is placed behind the encoded HARQ-ACK. It should be noted that if the first uplink information further includes the CSI report, the BFRQ information and the CSI report are separately encoded. When the above encoding scheme reaches an upper limit of a code rate required for transmission performance, uplink information with a lower priority is dropped based on the priority.

In a case that no resource conflict occurs in uplink transmission, the BFRQ information may be reported in two manners: explicit reporting and implicit reporting. In the explicit reporting manner, a periodic PUCCH resource used for the BFRQ information may be configured, and a bitmap manner is used on the PUCCH resource to indicate a cell in which a beam failure event occurs. Bits in the bitmap manner may be used as the dedicated SR. In the implicit reporting manner, a plurality of periodic PUCCH resources (or referred to as dedicated SR resources) may be configured, where each PUCCH resource index corresponds to a cell index.

In a case that a resource conflict occurs in uplink transmission, if the BFRQ information is originally sent in an explicit manner and a PUCCH payload is sufficient, sending may be performed through multiplexing based on the priority of each piece of information, and the BFRQ information is still explicitly reported. If the BFRQ information is originally sent in an implicit manner, the BFRQ information may still be sent in an implicit manner, that is, the BFRQ information and other information (for example, the HARQ-ACK) are sent on a PUCCH resource corresponding to a cell index. In this case, the BFRQ information does not include the cell index information. Certainly, the implicit manner may also be switched to the explicit manner. In this case, the BFRQ information and the HARQ-ACK are simultaneously sent on the second PUCCH, and the code rate is changed or the resource size of the second PUCCH is extended, or the HARQ-ACK and the BFRQ information are simultaneously sent on the first PUCCH, and the code rate is changed or the resource size of the first PUCCH is extended. In this case, the BFRQ information includes the cell index information.

Scenario 2: An uplink channel corresponding to the first uplink transmission is a third PUCCH used to transmit the BFRQ information, and an uplink channel corresponding to the second uplink transmission includes N first PUSCHs, where N is an integer greater than or equal to 1.

In this scenario, the third PUCCH and the N first PUSCHs may be located in a same cell, may be located in a same cell group, or may be located in different cell groups.

The first PUSCH may be a PUSCH in 2-step random access (2-step RACH).

Optionally, the sending second uplink information based on a priority of first uplink information includes at least one of the following:

sending the second uplink information by using the N first PUSCHs based on the priority of the first uplink information, where N is equal to 1; or

sending the second uplink information by using a PUSCH corresponding to a lowest cell index or a highest cell index in the N first PUSCHs based on the priority of the first uplink information, where N is an integer greater than 1.

In this implementation, regardless of uplink information carried on the third PUCCH, a first PUSCH is used by default to send a part or all of uplink information originally carried on a PUCCH and uplink information originally carried on the first PUSCH. When there are a plurality of first PUSCHs, a PUSCH corresponding to a lowest cell index or a highest cell index in the plurality of first PUSCHs is preferentially used to send a part or all of uplink information originally carried on a PUCCH and uplink information originally carried in a first PUSCH.

In this scenario, for a manner of sending the second uplink information, refer to the foregoing descriptions. To avoid repetition, details are not described again.

Scenario 3: An uplink channel corresponding to the first uplink transmission is a second PUSCH used to transmit the BFRQ information, and an uplink channel corresponding to the second uplink transmission includes M third PUSCHs, where M is an integer greater than or equal to 1.

The second PUSCH may be a PUSCH in 2-step random access, or the third PUSCH may be a PUSCH in 2-step random access.

Optionally, the sending second uplink information based on a priority of first uplink information includes at least one of the following:

sending the second uplink information by using a PUSCH corresponding to a lowest cell index or a highest cell index in the second PUSCH and the M third PUSCHs based on the priority of the first uplink information, where M is an integer greater than or equal to 1;

sending the second uplink information by using the second PUSCH based on the priority of the first uplink information;

sending the second uplink information by using the M third PUSCHs based on the priority of the first uplink information, where M is equal to 1; or

sending the second uplink information by using a PUSCH corresponding to a lowest cell index or a highest cell index in the M third PUSCHs based on the priority of the first uplink information, where M is an integer greater than 1.

If the second PUSCH is a PUSCH in 2-step random access, the priority of the BFRQ information may be determined as a highest priority, that is, the priority of the BFRQ information is always the highest.

In this scenario, for a manner of sending the second uplink information, refer to the foregoing descriptions. To avoid repetition, details are not described again.

Scenario 4: An uplink channel corresponding to the first uplink transmission is a fourth PUSCH used to transmit the BFRQ information, and an uplink channel corresponding to the second uplink transmission is a fourth PUCCH.

The fourth PUSCH may be a PUSCH in 2-step random access.

Optionally, the sending second uplink information based on a priority of first uplink information includes at least one of the following:

sending the second uplink information by using the fourth PUSCH based on the priority of the first uplink information; or

sending the second uplink information by using the fourth PUCCH based on the priority of the first uplink information.

If the fourth PUSCH is a PUSCH in 2-step random access, the priority of the BFRQ information may be determined as a highest priority, that is, the priority of the BFRQ information is always the highest.

In this scenario, for a manner of sending the second uplink information, refer to the foregoing descriptions. To avoid repetition, details are not described again.

Scenario 5: An uplink channel corresponding to the first uplink transmission is a fifth PUCCH used to transmit the BFRQ information or a fifth PUSCH used to transmit the BFRQ information; and an uplink channel corresponding to the second uplink transmission is a PRACH, or the information transmitted in the second uplink transmission is an SRS.

The fifth PUSCH may be a PUSCH in 2-step random access.

Optionally, the sending second uplink information based on a priority of first uplink information includes:

sending information with a highest priority in the first uplink information.

Certainly, the second uplink information may be sent through multiplexing by using the fifth PUCCH or the fifth PUSCH in descending order of priorities, such as at least two pieces of information in the BFRQ information, the information transmitted on the PRACH, and the SRS. The second uplink information may be sent through multiplexing by using a PRACH in descending order of priorities, such as at least two pieces of information in the BFRQ information and the information transmitted on the PRACH. This is not specifically described because it is easy to understand.

If the fifth PUSCH is a PUSCH in 2-step random access, the priority of the BFRQ information may be determined as a highest priority, that is, the priority of the BFRQ information is always the highest.

In this scenario, for a manner of sending the second uplink information, refer to the foregoing descriptions. To avoid repetition, details are not described again.

Scenario 6: An uplink channel corresponding to the first uplink transmission and an uplink channel corresponding to the second uplink transmission are respectively uplink channels of different cell groups.

In this scenario, the uplink sending manner may be determined based on a power constraint situation. For example, in a case of power sharing between cell groups, transmit power required for transmission performance of an uplink channel corresponding to information with a higher priority in the first uplink information is preferentially met based on the priority of the first uplink information, to reduce transmit power of an uplink channel corresponding to information with a lower priority in the first uplink information. In a case that power between cell groups is separately configured, uplink information is sent in each cell group in the foregoing implementations.

In view of the foregoing implementations, in a beam failure recovery process, when a resource collision occurs between uplink transmission used to transmit BFRQ information and other uplink transmission, a terminal may determine, based on a priority of uplink information, uplink information that needs to be sent. Because the priority of the uplink information is considered, the terminal can preferentially send uplink information with a higher priority, thereby ensuring proper uplink transmission, ensuring communication reliability of a communications system, and improving communication performance of the communications system.

FIG. 4 is a flowchart of an uplink transmission method according to an embodiment of the present disclosure. As shown in FIG. 4, the uplink transmission method is applied to a network side device, and the method includes the following steps.

Step 401: Receive first uplink information sent by a terminal.

The first uplink information is information sent by the terminal based on a priority of second uplink information in a case that a resource collision occurs between first uplink transmission and second uplink transmission, the first uplink information includes a part or all of the second uplink information, the second uplink information includes information transmitted in the first uplink transmission and information transmitted in the second uplink transmission, and the second uplink information includes a beam failure recovery request BFRQ information.

Step 402: Determine information content of the first uplink information based on a priority of second uplink information.

In this embodiment of the present disclosure, after receiving the first uplink information sent by the terminal and parsing the first uplink information, the network side device may determine the information content of the first uplink information based on a priority of uplink information. For example, if the terminal sends the first uplink information through dropping, the network side device may determine information with a highest priority as the first uplink information. If the terminal sends the first uplink information in a multiplexing manner, the network side device may sequentially determine the information content of the first uplink information in descending order of priorities.

Optionally, the priority of the second uplink information is determined based on at least one of the following priority relationships:

a priority relationship of each piece of information content in the second uplink information;

a priority relationship of a cell corresponding to each piece of information in the second uplink information; or

a priority relationship of an uplink channel corresponding to each piece of information in the second uplink information.

Optionally, a priority of information corresponding to a primary cell is higher than a priority of information corresponding to a secondary cell in the second uplink information.

Optionally, a priority of information transmitted on an aperiodic uplink channel is higher than a priority of information transmitted on a periodic uplink channel in the second uplink information; and/or

the priority of the information transmitted on the aperiodic uplink channel is higher than a priority of information transmitted on a semi-persistent uplink channel in the second uplink information.

Optionally, the second uplink information further includes at least one of a scheduling request SR, a hybrid automatic repeat request acknowledgement HARQ-ACK, a channel state information CSI report, uplink data information, a sounding reference signal SRS, or information transmitted on a physical random access channel PRACH; and

the priority relationship of each piece of information content in the second uplink information includes at least one of the following:

a priority of the BFRQ information is a highest priority;

the priority of the BFRQ information is higher than a priority of the HARQ-ACK;

the priority of the BFRQ information is higher than a priority of the SR;

the priority of the BFRQ information is higher than a priority of the CSI report;

the priority of the BFRQ information is higher than a priority of the SRS;

the priority of the BFRQ information is higher than a priority of the information transmitted on the PRACH;

the priority of the BFRQ information is higher than a priority of the uplink data information;

the priority of the BFRQ information is lower than the priority of the HARQ-ACK;

the priority of the BFRQ information is lower than the priority of the SR;

the priority of the BFRQ information is lower than the priority of the SRS; or

the priority of the BFRQ information is lower than the priority of the information transmitted on the PRACH.

Optionally, an uplink channel corresponding to the first uplink transmission is a first physical uplink control channel PUCCH used to transmit the BFRQ information, and an uplink channel corresponding to the second uplink transmission is a second PUCCH used to transmit uplink control information UCI; and

the receiving first uplink information sent by a terminal includes:

receiving a part or all of the BFRQ information and the UCI by using the first PUCCH or the second PUCCH, where

the UCI includes at least one of the SR, the HARQ-ACK, or the CSI report.

Optionally, the UCI includes the HARQ-ACK; and

the receiving first uplink information sent by a terminal includes:

receiving the BFRQ information and the HARQ-ACK by using the first PUCCH or the second PUCCH.

Optionally, the receiving the BFRQ information and the HARQ-ACK by using the first PUCCH or the second PUCCH includes at least one of the following:

extending a resource length of the first PUCCH, and receiving the BFRQ information and the HARQ-ACK by using the first PUCCH;

extending a resource length of the second PUCCH, and receiving the BFRQ information and the HARQ-ACK by using the second PUCCH;

changing a code rate of the BFRQ information and/or the HARQ-ACK, and receiving the BFRQ information and the HARQ-ACK by using the first PUCCH;

changing a code rate of the BFRQ information and/or the HARQ-ACK, and receiving the BFRQ information and the HARQ-ACK by using the second PUCCH; or

configuring a correspondence between the first PUCCH or the second PUCCH and a cell index, and receiving the BFRQ information and the HARQ-ACK by using a PUCCH that has a correspondence with a cell index in the first PUCCH and the second PUCCH.

Optionally, an uplink channel corresponding to the first uplink transmission is a third PUCCH used to transmit the BFRQ information, and an uplink channel corresponding to the second uplink transmission includes N first physical uplink shared channels PUSCHs, where N is an integer greater than or equal to 1.

Optionally, the receiving first uplink information sent by a terminal includes at least one of the following:

receiving the first uplink information by using the N first PUSCHs, where N is equal to 1; or

receiving the first uplink information by using a PUSCH corresponding to a lowest cell index or a highest cell index in the N first PUSCHs, where N is an integer greater than 1.

Optionally, an uplink channel corresponding to the first uplink transmission is a second PUSCH used to transmit the BFRQ information, and an uplink channel corresponding to the second uplink transmission includes M third PUSCHs, where M is an integer greater than or equal to 1.

Optionally, the receiving first uplink information sent by a terminal includes at least one of the following:

receiving the first uplink information by using a PUSCH corresponding to a lowest cell index or a highest cell index in the second PUSCH and the M third PUSCHs, where M is an integer greater than or equal to 1;

receiving the first uplink information by using the second PUSCH;

receiving the first uplink information by using the M third PUSCHs, where M is equal to 1; or

receiving the first uplink information by using a PUSCH corresponding to a lowest cell index or a highest cell index in the M third PUSCHs, where M is an integer greater than 1.

Optionally, an uplink channel corresponding to the first uplink transmission is a fourth PUSCH used to transmit the BFRQ information, and an uplink channel corresponding to the second uplink transmission is a fourth PUCCH.

Optionally, the receiving first uplink information sent by a terminal includes at least one of the following:

receiving the first uplink information by using the fourth PUSCH; or

receiving the first uplink information by using the fourth PUCCH.

Optionally, an uplink channel corresponding to the first uplink transmission is a fifth PUCCH used to transmit the BFRQ information or a fifth PUSCH used to transmit the BFRQ information; and

an uplink channel corresponding to the second uplink transmission is a physical random access channel PRACH, or the information transmitted in the second uplink transmission is a sounding reference signal SRS.

Optionally, the receiving first uplink information sent by a terminal includes:

receiving information with a highest priority in the first uplink information.

Optionally, at least one of the first PUSCH, the second PUSCH, the third PUSCH, the fourth PUSCH, or the fifth PUSCH is a PUSCH in 2-step random access.

Optionally, an uplink channel corresponding to the first uplink transmission and an uplink channel corresponding to the second uplink transmission are respectively uplink channels of different cell groups; and

the receiving first uplink information sent by a terminal includes:

in a case of power sharing between cell groups, receiving the uplink channel corresponding to the first uplink transmission and/or the uplink channel corresponding to the second uplink transmission, where

the terminal reduces, based on a priority of the first uplink information, transmit power of an uplink channel corresponding to information with a lower priority in the first uplink information.

Optionally, the BFRQ information includes at least one of a scheduling request SR used to indicate a beam failure event, new beam information, or index information of a cell in which a beam failure occurs.

In this embodiment of the present disclosure, in a beam failure recovery process, when a resource collision occurs between uplink transmission used to transmit BFRQ information and other uplink transmission, a network side device may distinguish, based on a priority of uplink information, uplink information received by the network side device. In this way, because the priority of the uplink information is considered, uplink information with a higher priority can be preferentially sent, thereby ensuring proper uplink transmission, ensuring communication reliability of a communications system, and improving communication performance of the communications system.

It should be noted that this embodiment of the present disclosure is used as an embodiment of a network side device corresponding to the embodiment shown in FIG. 3. For implementations of this embodiment, refer to related descriptions of the embodiment shown in FIG. 3. The same beneficial effects can be achieved. To avoid repetition, details are not described herein again.

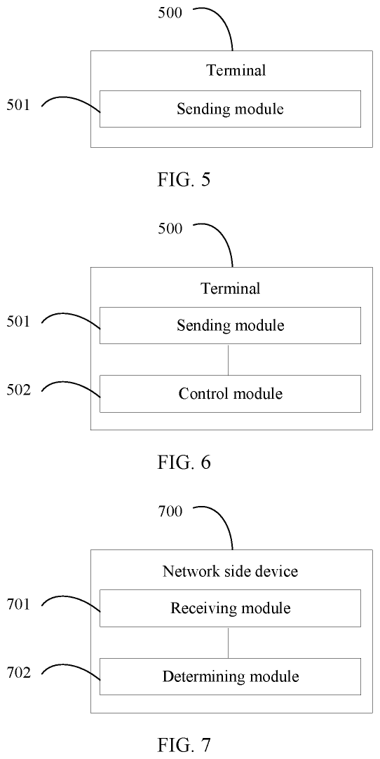

FIG. 5 is a structural diagram of a terminal according to an embodiment of the present disclosure. As shown in FIG. 5, a terminal 500 includes:

a sending module 501, configured to send second uplink information based on a priority of first uplink information in a case that a resource collision occurs between first uplink transmission and second uplink transmission, where

the first uplink information includes information transmitted in the first uplink transmission and information transmitted in the second uplink transmission, the first uplink information includes beam failure recovery request BFRQ information, and the second uplink information includes a part or all of the first uplink information.

Optionally, the sending module 501 is configured to perform at least one of the following:

sending information with a highest priority in the first uplink information; or

sending at least two pieces of information in the first uplink information through multiplexing in descending order of priorities.

Optionally, the priority of the first uplink information is determined based on at least one of the following priority relationships:

a priority relationship of each piece of information content in the first uplink information;

a priority relationship of a cell corresponding to each piece of information in the first uplink information; or

a priority relationship of an uplink channel corresponding to each piece of information in the first uplink information.

Optionally, a priority of information corresponding to a primary cell is higher than a priority of information corresponding to a secondary cell in the first uplink information.

Optionally, a priority of information transmitted on an aperiodic uplink channel is higher than a priority of information transmitted on a periodic uplink channel in the first uplink information; and/or

the priority of the information transmitted on the aperiodic uplink channel is higher than a priority of information transmitted on a semi-persistent uplink channel in the first uplink information.

Optionally, the first uplink information further includes at least one of a scheduling request SR, a hybrid automatic repeat request acknowledgement HARQ-ACK, a channel state information CSI report, uplink data information, a sounding reference signal SRS, or information transmitted on a physical random access channel PRACH; and

the priority relationship of each piece of information content in the first uplink information includes at least one of the following:

a priority of the BFRQ information is a highest priority;

the priority of the BFRQ information is higher than a priority of the HARQ-ACK;

the priority of the BFRQ information is higher than a priority of the SR;

the priority of the BFRQ information is higher than a priority of the CSI report;

the priority of the BFRQ information is higher than a priority of the SRS;

the priority of the BFRQ information is higher than a priority of the information transmitted on the PRACH;

the priority of the BFRQ information is higher than a priority of the uplink data information;

the priority of the BFRQ information is lower than the priority of the HARQ-ACK;

the priority of the BFRQ information is lower than the priority of the SR;

the priority of the BFRQ information is lower than the priority of the SRS; or

the priority of the BFRQ information is lower than the priority of the information transmitted on the PRACH.

Optionally, an uplink channel corresponding to the first uplink transmission is a first physical uplink control channel PUCCH used to transmit the BFRQ information, and an uplink channel corresponding to the second uplink transmission is a second PUCCH used to transmit uplink control information UCI; and

the sending module 501 may be configured to:

send a part or all of the BFRQ information and the UCI by using the first PUCCH or the second PUCCH based on the priority of the first uplink information, where

the UCI includes at least one of the SR, the HARQ-ACK, or the CSI report.

Optionally, the UCI includes the HARQ-ACK.

The sending module 501 may be configured to:

send the BFRQ information and the HARQ-ACK through multiplexing by using the first PUCCH or the second PUCCH in descending order of priorities.

Optionally, the sending module 501 may be configured to perform at least one of the following:

extending a resource length of the first PUCCH, and sending the BFRQ information and the HARQ-ACK through multiplexing by using the first PUCCH;

extending a resource length of the second PUCCH, and sending the BFRQ information and the HARQ-ACK through multiplexing by using the second PUCCH;

changing a code rate of the BFRQ information and/or the HARQ-ACK, and sending the BFRQ information and the HARQ-ACK through multiplexing by using the first PUCCH;

changing a code rate of the BFRQ information and/or the HARQ-ACK, and sending the BFRQ information and the HARQ-ACK through multiplexing by using the second PUCCH; or

sending the BFRQ information and the HARQ-ACK through multiplexing by using a PUCCH that has a correspondence with a cell index in the first PUCCH and the second

PUCCH.

Optionally, an uplink channel corresponding to the first uplink transmission is a third PUCCH used to transmit the BFRQ information, and an uplink channel corresponding to the second uplink transmission includes N first physical uplink shared channels PUSCHs, where N is an integer greater than or equal to 1.

Optionally, the sending module 501 may be configured to perform at least one of the following:

sending the second uplink information by using the N first PUSCHs based on the priority of the first uplink information, where N is equal to 1; or

sending the second uplink information by using a PUSCH corresponding to a lowest cell index or a highest cell index in the N first PUSCHs based on the priority of the first uplink information, where N is an integer greater than 1.

Optionally, an uplink channel corresponding to the first uplink transmission is a second PUSCH used to transmit the BFRQ information, and an uplink channel corresponding to the second uplink transmission includes M third PUSCHs, where M is an integer greater than or equal to 1.

Optionally, the sending module 501 may be configured to perform at least one of the following:

sending the second uplink information by using a PUSCH corresponding to a lowest cell index or a highest cell index in the second PUSCH and the M third PUSCHs based on the priority of the first uplink information, where M is an integer greater than or equal to 1;

sending the second uplink information by using the second PUSCH based on the priority of the first uplink information;

sending the second uplink information by using the M third PUSCHs based on the priority of the first uplink information, where M is equal to 1; or

sending the second uplink information by using a PUSCH corresponding to a lowest cell index or a highest cell index in the M third PUSCHs based on the priority of the first uplink information, where M is an integer greater than 1.

Optionally, an uplink channel corresponding to the first uplink transmission is a fourth PUSCH used to transmit the BFRQ information, and an uplink channel corresponding to the second uplink transmission is a fourth PUCCH.

Optionally, the sending module 501 may be configured to perform at least one of the following:

sending the second uplink information by using the fourth PUSCH based on the priority of the first uplink information; or

sending the second uplink information by using the fourth PUCCH based on the priority of the first uplink information.

Optionally, an uplink channel corresponding to the first uplink transmission is a fifth PUCCH used to transmit the BFRQ information or a fifth PUSCH used to transmit the BFRQ information; and

an uplink channel corresponding to the second uplink transmission is a physical random access channel PRACH, or the information transmitted in the second uplink transmission is a sounding reference signal SRS.

Optionally, the sending module 501 may be configured to:

send information with a highest priority in the first uplink information.

Optionally, at least one of the first PUSCH, the second PUSCH, the third PUSCH, the fourth PUSCH, or the fifth PUSCH is a PUSCH in 2-step random access.

Optionally, an uplink channel corresponding to the first uplink transmission and an uplink channel corresponding to the second uplink transmission are respectively uplink channels of different cell groups.

As shown in FIG. 6, the terminal 500 further includes:

a control module 502, configured to: in a case of power sharing between cell groups, reduce, based on the priority of the first uplink information, transmit power of an uplink channel corresponding to information with a lower priority in the first uplink information.

Optionally, the BFRQ information includes at least one of a scheduling request SR used to indicate a beam failure event, new beam information, or index information of a cell in which a beam failure occurs.

It should be noted that the terminal 500 in this embodiment of the present disclosure may be the terminal in any implementation in the method embodiments. Any implementation of the terminal in the method embodiments may be implemented by the terminal 500 in this embodiment of the present disclosure, and a same beneficial effect is achieved. To avoid repetition, details are not described herein again.

FIG. 7 is a structural diagram of a network side device according to an embodiment of the present disclosure. As shown in FIG. 7, a network side device 700 includes:

a receiving module 701, configured to receive first uplink information sent by a terminal, where the first uplink information is information sent by the terminal based on a priority of second uplink information in a case that a resource collision occurs between first uplink transmission and second uplink transmission, the first uplink information includes a part or all of the second uplink information, the second uplink information includes information transmitted in the first uplink transmission and information transmitted in the second uplink transmission, and the second uplink information includes beam failure recovery request BFRQ information; and

a determining module 702, configured to determine information content of the first uplink information based on the priority of the second uplink information.

Optionally, the priority of the second uplink information is determined based on at least one of the following priority relationships:

a priority relationship of each piece of information content in the second uplink information;

a priority relationship of a cell corresponding to each piece of information in the second uplink information; or

a priority relationship of an uplink channel corresponding to each piece of information in the second uplink information.

Optionally, a priority of information corresponding to a primary cell is higher than a priority of information corresponding to a secondary cell in the second uplink information.

Optionally, a priority of information transmitted on an aperiodic uplink channel is higher than a priority of information transmitted on a periodic uplink channel in the second uplink information; and/or

the priority of the information transmitted on the aperiodic uplink channel is higher than a priority of information transmitted on a semi-persistent uplink channel in the second uplink information.

Optionally, the second uplink information further includes at least one of a scheduling request SR, a hybrid automatic repeat request acknowledgement HARQ-ACK, a channel state information CSI report, uplink data information, a sounding reference signal SRS, or information transmitted on a physical random access channel PRACH; and

the priority relationship of each piece of information content in the second uplink information includes at least one of the following:

a priority of the BFRQ information is a highest priority;

the priority of the BFRQ information is higher than a priority of the HARQ-ACK;

the priority of the BFRQ information is higher than a priority of the SR;

the priority of the BFRQ information is higher than a priority of the CSI report;

the priority of the BFRQ information is higher than a priority of the SRS;

the priority of the BFRQ information is higher than a priority of the information transmitted on the PRACH;

the priority of the BFRQ information is higher than a priority of the uplink data information;

the priority of the BFRQ information is lower than the priority of the HARQ-ACK;

the priority of the BFRQ information is lower than the priority of the SR;

the priority of the BFRQ information is lower than the priority of the SRS; or

the priority of the BFRQ information is lower than the priority of the information transmitted on the PRACH.

Optionally, an uplink channel corresponding to the first uplink transmission is a first physical uplink control channel PUCCH used to transmit the BFRQ information, and an uplink channel corresponding to the second uplink transmission is a second PUCCH used to transmit uplink control information UCI; and

the receiving module 701 is configured to:

receive a part or all of the BFRQ information and the UCI by using the first PUCCH or the second PUCCH, where

the UCI includes at least one of the SR, the HARQ-ACK, or the CSI report.

Optionally, the UCI includes the HARQ-ACK.

The receiving module 701 is configured to:

receive the BFRQ information and the HARQ-ACK by using the first PUCCH or the second PUCCH.

Optionally, the receiving module 701 is configured to perform at least one of the following:

extending a resource length of the first PUCCH, and receiving the BFRQ information and the HARQ-ACK by using the first PUCCH;

extending a resource length of the second PUCCH, and receiving the BFRQ information and the HARQ-ACK by using the second PUCCH;

changing a code rate of the BFRQ information and/or the HARQ-ACK, and receiving the BFRQ information and the HARQ-ACK by using the first PUCCH;

changing a code rate of the BFRQ information and/or the HARQ-ACK, and receiving the BFRQ information and the HARQ-ACK by using the second PUCCH; or

configuring a correspondence between the first PUCCH or the second PUCCH and a cell index, and receiving the BFRQ information and the HARQ-ACK by using a PUCCH that has a correspondence with a cell index in the first PUCCH and the second PUCCH.

Optionally, an uplink channel corresponding to the first uplink transmission is a third PUCCH used to transmit the BFRQ information, and an uplink channel corresponding to the second uplink transmission includes N first physical uplink shared channels PUSCHs, where N is an integer greater than or equal to 1.

Optionally, the receiving module 701 is configured to perform at least one of the following:

receiving the first uplink information by using the N first PUSCHs, where N is equal to 1; or

receiving the first uplink information by using a PUSCH corresponding to a lowest cell index or a highest cell index in the N first PUSCHs, where N is an integer greater than 1.

Optionally, an uplink channel corresponding to the first uplink transmission is a second PUSCH used to transmit the BFRQ information, and an uplink channel corresponding to the second uplink transmission includes M third PUSCHs, where M is an integer greater than or equal to 1.

Optionally, the receiving module 701 is configured to perform at least one of the following:

receiving the first uplink information by using a PUSCH corresponding to a lowest cell index or a highest cell index in the second PUSCH and the M third PUSCHs, where M is an integer greater than or equal to 1;

receiving the first uplink information by using the second PUSCH;

receiving the first uplink information by using the M third PUSCHs, where M is equal to 1; or

receiving the first uplink information by using a PUSCH corresponding to a lowest cell index or a highest cell index in the M third PUSCHs, where M is an integer greater than 1.

Optionally, an uplink channel corresponding to the first uplink transmission is a fourth PUSCH used to transmit the BFRQ information, and an uplink channel corresponding to the second uplink transmission is a fourth PUCCH.

Optionally, the receiving module 701 is configured to perform at least one of the following:

receiving the first uplink information by using the fourth PUSCH; or

receiving the first uplink information by using the fourth PUCCH.

Optionally, an uplink channel corresponding to the first uplink transmission is a fifth PUCCH used to transmit the BFRQ information or a fifth PUSCH used to transmit the BFRQ information; and

an uplink channel corresponding to the second uplink transmission is a physical random access channel PRACH, or the information transmitted in the second uplink transmission is a sounding reference signal SRS.

Optionally, the receiving first uplink information sent by a terminal includes:

receiving information with a highest priority in the first uplink information.

Optionally, at least one of the first PUSCH, the second PUSCH, the third PUSCH, the fourth PUSCH, or the fifth PUSCH is a PUSCH in 2-step random access.

Optionally, an uplink channel corresponding to the first uplink transmission and an uplink channel corresponding to the second uplink transmission are respectively uplink channels of different cell groups.

Optionally, the receiving module 701 is configured to:

in a case of power sharing between cell groups, receive the uplink channel corresponding to the first uplink transmission and/or the uplink channel corresponding to the second uplink transmission, where

the terminal reduces, based on a priority of the first uplink information, transmit power of an uplink channel corresponding to information with a lower priority in the first uplink information.

Optionally, the BFRQ information includes at least one of a scheduling request SR used to indicate a beam failure event, new beam information, or index information of a cell in which a beam failure occurs.

It should be noted that the foregoing network side device 700 in this embodiment of the present disclosure may be the network side device in any implementation in the method embodiment. Any implementation of the network side device in the method embodiment may be implemented by the foregoing network side device 700 in this embodiment of the present disclosure, and a same beneficial effect is achieved. To avoid repetition, details are not described herein again.

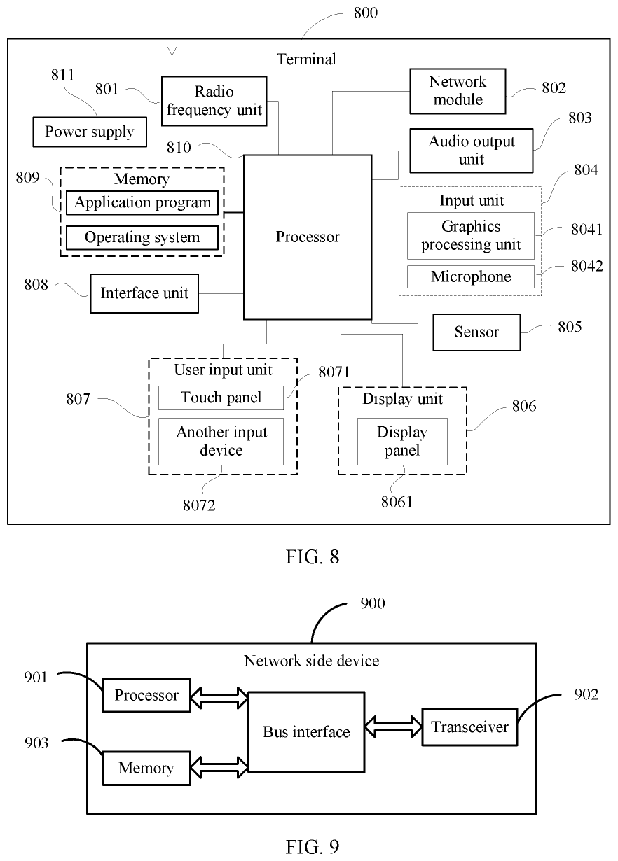

FIG. 8 is a schematic structural diagram of hardware of a terminal implementing embodiments of the present disclosure. The terminal 800 includes but is not limited to: a radio frequency unit 801, a network module 802, an audio output unit 803, an input unit 804, a sensor 805, a display unit 806, a user input unit 807, an interface unit 808, a memory 809, a processor 810, a power supply 811, and other components. A person skilled in the art may understand that a structure of the terminal shown in FIG. 8 does not constitute a limitation on the terminal, and the terminal may include more or fewer components than those shown in the figure, or combine some components, or have different component arrangements. In this embodiment of the present disclosure, the terminal includes but is not limited to a mobile phone, a tablet computer, a laptop computer, a palmtop computer, an in-vehicle terminal, a wearable device, a pedometer, and the like.

The radio frequency unit 801 is configured to:

send second uplink information based on a priority of first uplink information in a case that a resource collision occurs between first uplink transmission and second uplink transmission, where

the first uplink information includes information transmitted in the first uplink transmission and information transmitted in the second uplink transmission, the first uplink information includes beam failure recovery request BFRQ information, and the second uplink information includes a part or all of the first uplink information.

Optionally, the radio frequency unit 801 is further configured to perform at least one of the following:

sending information with a highest priority in the first uplink information; or

sending at least two pieces of information in the first uplink information through multiplexing in descending order of priorities.

Optionally, the priority of the first uplink information is determined based on at least one of the following priority relationships:

a priority relationship of each piece of information content in the first uplink information;

a priority relationship of a cell corresponding to each piece of information in the first uplink information; or

a priority relationship of an uplink channel corresponding to each piece of information in the first uplink information.

Optionally, a priority of information corresponding to a primary cell is higher than a priority of information corresponding to a secondary cell in the first uplink information.

Optionally, a priority of information transmitted on an aperiodic uplink channel is higher than a priority of information transmitted on a periodic uplink channel in the first uplink information; and/or

the priority of the information transmitted on the aperiodic uplink channel is higher than a priority of information transmitted on a semi-persistent uplink channel in the first uplink information.

Optionally, the first uplink information further includes at least one of a scheduling request SR, a hybrid automatic repeat request acknowledgement HARQ-ACK, a channel state information CSI report, uplink data information, a sounding reference signal SRS, or information transmitted on a physical random access channel PRACH; and

the priority relationship of each piece of information content in the first uplink information includes at least one of the following:

a priority of the BFRQ information is a highest priority;

the priority of the BFRQ information is higher than a priority of the HARQ-ACK;

the priority of the BFRQ information is higher than a priority of the SR;

the priority of the BFRQ information is higher than a priority of the CSI report;

the priority of the BFRQ information is higher than a priority of the SRS;

the priority of the BFRQ information is higher than a priority of the information transmitted on the PRACH;

the priority of the BFRQ information is higher than a priority of the uplink data information;

the priority of the BFRQ information is lower than the priority of the HARQ-ACK;

the priority of the BFRQ information is lower than the priority of the SR;

the priority of the BFRQ information is lower than the priority of the SRS; or

the priority of the BFRQ information is lower than the priority of the information transmitted on the PRACH.

Optionally, an uplink channel corresponding to the first uplink transmission is a first physical uplink control channel PUCCH used to transmit the BFRQ information, and an uplink channel corresponding to the second uplink transmission is a second PUCCH used to transmit uplink control information UCI; and

the radio frequency unit 801 may be configured to:

send a part or all of the BFRQ information and the UCI by using the first PUCCH or the second PUCCH based on the priority of the first uplink information, where

the UCI includes at least one of the SR, the HARQ-ACK, or the CSI report.

Optionally, the UCI includes the HARQ-ACK.

The radio frequency unit 801 may be configured to:

send the BFRQ information and the HARQ-ACK through multiplexing by using the first PUCCH or the second PUCCH in descending order of priorities.

Optionally, the sending module 501 may be configured to perform at least one of the following:

extending a resource length of the first PUCCH, and sending the BFRQ information and the HARQ-ACK through multiplexing by using the first PUCCH;

extending a resource length of the second PUCCH, and sending the BFRQ information and the HARQ-ACK through multiplexing by using the second PUCCH;

changing a code rate of the BFRQ information and/or the HARQ-ACK, and sending the BFRQ information and the HARQ-ACK through multiplexing by using the first PUCCH;

changing a code rate of the BFRQ information and/or the HARQ-ACK, and sending the BFRQ information and the HARQ-ACK through multiplexing by using the second PUCCH; or

sending the BFRQ information and the HARQ-ACK through multiplexing by using a PUCCH that has a correspondence with a cell index in the first PUCCH and the second PUCCH.

Optionally, an uplink channel corresponding to the first uplink transmission is a third PUCCH used to transmit the BFRQ information, and an uplink channel corresponding to the second uplink transmission includes N first physical uplink shared channels PUSCHs, where N is an integer greater than or equal to 1.

Optionally, the radio frequency unit 801 may be configured to perform at least one of the following:

sending the second uplink information by using the N first PUSCHs based on the priority of the first uplink information, where N is equal to 1; or

sending the second uplink information by using a PUSCH corresponding to a lowest cell index or a highest cell index in the N first PUSCHs based on the priority of the first uplink information, where N is an integer greater than 1.

Optionally, an uplink channel corresponding to the first uplink transmission is a second PUSCH used to transmit the BFRQ information, and an uplink channel corresponding to the second uplink transmission includes M third PUSCHs, where M is an integer greater than or equal to 1.

Optionally, the radio frequency unit 801 may be configured to perform at least one of the following:

sending the second uplink information by using a PUSCH corresponding to a lowest cell index or a highest cell index in the second PUSCH and the M third PUSCHs based on the priority of the first uplink information, where M is an integer greater than or equal to 1;

sending the second uplink information by using the second PUSCH based on the priority of the first uplink information;

sending the second uplink information by using the M third PUSCHs based on the priority of the first uplink information, where M is equal to 1; or

sending the second uplink information by using a PUSCH corresponding to a lowest cell index or a highest cell index in the M third PUSCHs based on the priority of the first uplink information, where M is an integer greater than 1.

Optionally, an uplink channel corresponding to the first uplink transmission is a fourth PUSCH used to transmit the BFRQ information, and an uplink channel corresponding to the second uplink transmission is a fourth PUCCH.

Optionally, the radio frequency unit 801 may be configured to perform at least one of the following:

sending the second uplink information by using the fourth PUSCH based on the priority of the first uplink information; or

sending the second uplink information by using the fourth PUCCH based on the priority of the first uplink information.

Optionally, an uplink channel corresponding to the first uplink transmission is a fifth PUCCH used to transmit the BFRQ information or a fifth PUSCH used to transmit the BFRQ information; and

an uplink channel corresponding to the second uplink transmission is a physical random access channel PRACH, or the information transmitted in the second uplink transmission is a sounding reference signal SRS.

Optionally, the radio frequency unit 801 may be configured to:

send information with a highest priority in the first uplink information.

Optionally, at least one of the first PUSCH, the second PUSCH, the third PUSCH, the fourth PUSCH, or the fifth PUSCH is a PUSCH in 2-step random access.

Optionally, an uplink channel corresponding to the first uplink transmission and an uplink channel corresponding to the second uplink transmission are respectively uplink channels of different cell groups.

The processor 810 is configured to:

in a case of power sharing between cell groups, reduce, based on the priority of the first uplink information, transmit power of an uplink channel corresponding to information with a lower priority in the first uplink information.

Optionally, the BFRQ information includes at least one of a scheduling request SR used to indicate a beam failure event, new beam information, or index information of a cell in which a beam failure occurs.

In the embodiments of the present disclosure, in a beam failure recovery process, when a resource collision occurs between uplink transmission used to transmit BFRQ information and other uplink transmission, a terminal may determine, based on a priority of uplink information, uplink information that needs to be sent. Because the priority of the uplink information is considered, the terminal can preferentially send uplink information with a higher priority, thereby ensuring proper uplink transmission, ensuring communication reliability of a communications system, and improving communication performance of the communications system.

It should be understood that, in this embodiment of the present disclosure, the radio frequency unit 801 may be configured to receive and send information or a signal in a call process. For example, after receiving downlink data from a base station, the radio frequency unit 801 sends the downlink data to the processor 810 for processing. In addition, the radio frequency unit 801 sends uplink data to the base station. Usually, the radio frequency unit 801 includes but is not limited to an antenna, at least one amplifier, a transceiver, a coupler, a low noise amplifier, a duplexer, and the like. In addition, the radio frequency unit 801 may communicate with a network and another device through a wireless communication system.

The terminal provides wireless broadband Internet access for the user by using the network module 802, for example, helping the user to send and receive an e-mail, brows a web page, and access streaming media.

The audio output unit 803 may convert audio data received by the radio frequency unit 801 or the network module 802 or stored in the memory 809 into an audio signal and output the audio signal as a sound In addition, the audio output unit 803 may further provide an audio output (for example, a call signal received voice, or a message received voice) related to a specific function implemented by the terminal 800. The audio output unit 803 includes a speaker, a buzzer, a telephone receiver, and the like.

The input unit 804 is configured to receive an audio or video signal. The input unit 804 may include a graphics processing unit (GPU) 8041 and a microphone 8042. The graphics processing unit 8041 processes image data of a static image or video obtained by an image capture apparatus (such as, a camera) in a video capture mode or an image capture mode. A processed image frame may be displayed on the display unit 806. The image frame processed by the graphics processing unit 8041 may be stored in the memory 809 (or another storage medium) or sent by using the radio frequency unit 801 or the network module 802. The microphone 8042 may receive a sound and can process such sound into audio data. Processed audio data may be converted, in telephone call mode, into a format that may be sent to a mobile communication base station via the radio frequency unit 801 for output.

The terminal 800 further includes at least one type of sensor 805, such as a light sensor, a motion sensor, and another sensor. The optional sensor includes an ambient light sensor and a proximity sensor. The ambient light sensor may adjust luminance of the display panel 8061 based on brightness of ambient light, and the proximity sensor may disable the display panel 8061 and backlight when the terminal 800 approaches an ear. As a type of the motion sensor, an accelerometer sensor may detect an acceleration value in each direction (generally, three axes), and detect a value and a direction of gravity when the accelerometer sensor is static, and may be used in an application for recognizing a mobile terminal posture (such as screen switching between landscape and portrait modes, a related game, or magnetometer posture calibration), a function related to vibration recognition (such as a pedometer or a knock), and the like. The sensor 805 may further include a fingerprint sensor, a pressure sensor, an iris sensor, a molecular sensor, a gyroscope, a barometer, a hygrometer, a thermometer, an infrared sensor, and the like. Details are not described herein.

The display unit 806 is configured to display information entered by a user or information provided for a user. The display unit 806 may include a display panel 8061. The display panel 8061 may be configured in a form of a liquid crystal display (LCD), an organic light-emitting diode (OLED), or the like.

The user input unit 807 may be configured to receive input numeral or character information, and generate key signal input related to user setting and functional control of the terminal. The user input unit 807 includes a touch panel 8071 and another input device 8072. The touch panel 8071 is further referred to as a touchscreen, and may collect a touch operation performed by a user on or near the touch panel 8071 (such as an operation performed by a user on the touch panel 8071 or near the touch panel 8071 by using any proper object or accessory, such as a finger or a stylus). The touch panel 8071 may include two parts: a touch detection apparatus and a touch controller. The touch detection apparatus detects a touch position of the user, detects a signal brought by the touch operation, and sends the signal to the touch controller. The touch controller receives touch information from the touch detection apparatus, converts the touch information into touch point coordinates, and sends the touch point coordinates to the processor 810, and can receive and execute a command sent by the processor 810. In addition, the touch panel 8071 may be of a resistive type, a capacitive type, an infrared type, a surface acoustic wave type, or the like. The user input unit 807 may include another input device 8072 in addition to the touch panel 8071. The another input device 8072 may include but is not limited to a physical keyboard, a functional button (such as a volume control button or a power on/off button), a trackball, a mouse, and a joystick. Details are not described herein.

Optionally, the touch panel 8071 may cover the display panel 8061. When detecting the touch operation on or near the touch panel 8071, the touch panel 8071 transmits the touch operation to the processor 810 to determine a type of a touch event, and then the processor 810 provides corresponding visual output on the display panel 8061 based on the type of the touch event. In FIG. 8, the touch panel 8071 and the display panel 8061 are used as two independent components to implement input and output functions of the terminal. However, in some embodiments, the touch panel 8071 and the display panel 8061 may be integrated to implement the input and output functions of the terminal. This is not specifically limited herein.

The interface unit 808 is an interface connecting an external apparatus and the terminal 800. For example, the external apparatus may include a wired or wireless headphone port, an external power supply (or a battery charger) port, a wired or wireless data port, a storage card port, a port used to connect to an apparatus having an identity module, an audio input/output (I/O) port, a video I/O port, a headset port, and the like. The interface unit 808 may be configured to receive an input (such as data information or electric power) from the external apparatus and transmit the received input to one or more elements of the terminal 800, or may be configured to transmit data between the terminal 800 and the external apparatus.

The memory 809 may be configured to store a software program and various data. The memory 809 may mainly include a program storage area and a data storage area. The program storage area may store an operating system, an application required by at least one function (such as a sound play function or an image play function), and the like. The data storage area may store data (such as audio data or an address book) created based on use of the mobile phone, and the like. In addition, the memory 809 may include a high-speed random access memory, and may further include a nonvolatile memory, for example, at least one magnetic disk storage device, a flash storage device, or another volatile solid-state storage device.

The processor 810 is a control center of the terminal, and is connected to all parts of the entire terminal by using various interfaces and lines, and performs various functions of the terminal and processes data by running or executing the software program and/or the module that are stored in the memory 809 and invoking the data stored in the memory 809, to implement overall monitoring on the terminal. The processor 810 may include one or more processing units. Optionally, an application processor and a modem processor may be integrated into the processor 810. The application processor mainly processes an operating system, a user interface, an application, and the like. The modem processor mainly processes wireless communications. It can be understood that alternatively, the modem processor may not be integrated into the processor 810.

The terminal 800 may further include the power supply 811 (such as a battery) that supplies power to each component. Optionally, the power supply 811 may be logically connected to the processor 810 by using a power management system, so as to implement functions such as charging, discharging, and power consumption management by using the power management system.

In addition, the terminal 800 includes some function modules not shown, and details are not described herein.

Optionally, an embodiment of the present disclosure further provides a terminal, including a processor 810, a memory 809, and a computer program that is stored in the memory 809 and that can run on the processor 810. When the computer program is executed by the processor 810, the foregoing processes of the uplink transmission method embodiment are implemented and a same technical effect can be achieved. To avoid repetition, details are not described herein again.

It should be noted that the terminal 800 in this embodiment may be the terminal in any implementation in the method embodiment in the embodiments of the present disclosure, and any implementation of the terminal in the method embodiment in the embodiments of the present disclosure may be implemented by the foregoing terminal 800 in this embodiment, and a same beneficial effect is achieved. Details are not described herein again.

FIG. 9 is a structural diagram of a network side device according to an embodiment of the present disclosure. As shown in FIG. 9, a network side device 900 includes a processor 901, a transceiver 902, a memory 903, and a bus interface.

The transceiver 902 is configured to:

receive first uplink information sent by a terminal, where the first uplink information is information sent by the terminal based on a priority of second uplink information in a case that a resource collision occurs between first uplink transmission and second uplink transmission, the first uplink information includes a part or all of the second uplink information, the second uplink information includes information transmitted in the first uplink transmission and information transmitted in the second uplink transmission, and the second uplink information includes beam failure recovery request BFRQ information; and

the transceiver 902 or the processor 901 is configured to:

determine information content of the first uplink information based on the priority of the second uplink information.

Optionally, the priority of the second uplink information is determined based on at least one of the following priority relationships:

a priority relationship of each piece of information content in the second uplink information;

a priority relationship of a cell corresponding to each piece of information in the second uplink information; or

a priority relationship of an uplink channel corresponding to each piece of information in the second uplink information.

Optionally, a priority of information corresponding to a primary cell is higher than a priority of information corresponding to a secondary cell in the second uplink information.

Optionally, a priority of information transmitted on an aperiodic uplink channel is higher than a priority of information transmitted on a periodic uplink channel in the second uplink information; and/or

the priority of the information transmitted on the aperiodic uplink channel is higher than a priority of information transmitted on a semi-persistent uplink channel in the second uplink information.

Optionally, the second uplink information further includes at least one of a scheduling request SR, a hybrid automatic repeat request acknowledgement HARQ-ACK, a channel state information CSI report, uplink data information, a sounding reference signal SRS, or information transmitted on a physical random access channel PRACH; and

the priority relationship of each piece of information content in the second uplink information includes at least one of the following:

a priority of the BFRQ information is a highest priority;

the priority of the BFRQ information is higher than a priority of the HARQ-ACK;

the priority of the BFRQ information is higher than a priority of the SR;

the priority of the BFRQ information is higher than a priority of the CSI report;

the priority of the BFRQ information is higher than a priority of the SRS;

the priority of the BFRQ information is higher than a priority of the information transmitted on the PRACH;

the priority of the BFRQ information is higher than a priority of the uplink data information;

the priority of the BFRQ information is lower than the priority of the HARQ-ACK;

the priority of the BFRQ information is lower than the priority of the SR;

the priority of the BFRQ information is lower than the priority of the SRS; or

the priority of the BFRQ information is lower than the priority of the information transmitted on the PRACH.

Optionally, an uplink channel corresponding to the first uplink transmission is a first physical uplink control channel PUCCH used to transmit the BFRQ information, and an uplink channel corresponding to the second uplink transmission is a second PUCCH used to transmit uplink control information UCI; and

the transceiver 902 or the processor 901 is configured to:

receive a part or all of the BFRQ information and the UCI by using the first PUCCH or the second PUCCH, where

the UCI includes at least one of the SR, the HARQ-ACK, or the CSI report.

Optionally, the UCI includes the HARQ-ACK.

The transceiver 902 or the processor 901 is configured to:

receive the BFRQ information and the HARQ-ACK by using the first PUCCH or the second PUCCH.

Optionally, the transceiver 902 or the processor 901 is configured to at least one of the following:

extending a resource length of the first PUCCH, and receiving the BFRQ information and the HARQ-ACK by using the first PUCCH;

extending a resource length of the second PUCCH, and receiving the BFRQ information and the HARQ-ACK by using the second PUCCH;

changing a code rate of the BFRQ information and/or the HARQ-ACK, and receiving the BFRQ information and the HARQ-ACK by using the first PUCCH;

changing a code rate of the BFRQ information and/or the HARQ-ACK, and receiving the BFRQ information and the HARQ-ACK by using the second PUCCH; or

configuring a correspondence between the first PUCCH or the second PUCCH and a cell index, and receiving the BFRQ information and the HARQ-ACK by using a PUCCH that has a correspondence with a cell index in the first PUCCH and the second PUCCH.

Optionally, an uplink channel corresponding to the first uplink transmission is a third PUCCH used to transmit the BFRQ information, and an uplink channel corresponding to the second uplink transmission includes N first physical uplink shared channels PUSCHs, where N is an integer greater than or equal to 1.

Optionally, the transceiver 902 or the processor 901 is configured to at least one of the following:

receiving the first uplink information by using the N first PUSCHs, where N is equal to 1; or

receiving the first uplink information by using a PUSCH corresponding to a lowest cell index or a highest cell index in the N first PUSCHs, where N is an integer greater than 1.

Optionally, an uplink channel corresponding to the first uplink transmission is a second PUSCH used to transmit the BFRQ information, and an uplink channel corresponding to the second uplink transmission includes M third PUSCHs, where M is an integer greater than or equal to 1.

Optionally, the transceiver 902 or the processor 901 is configured to at least one of the following:

receiving the first uplink information by using a PUSCH corresponding to a lowest cell index or a highest cell index in the second PUSCH and the M third PUSCHs, where M is an integer greater than or equal to 1;

receiving the first uplink information by using the second PUSCH;

receiving the first uplink information by using the M third PUSCHs, where M is equal to 1; or

receiving the first uplink information by using a PUSCH corresponding to a lowest cell index or a highest cell index in the M third PUSCHs, where M is an integer greater than 1.

Optionally, an uplink channel corresponding to the first uplink transmission is a fourth PUSCH used to transmit the BFRQ information, and an uplink channel corresponding to the second uplink transmission is a fourth PUCCH.

Optionally, the transceiver 902 or the processor 901 is configured to at least one of the following:

receiving the first uplink information by using the fourth PUSCH; or

receiving the first uplink information by using the fourth PUCCH.

Optionally, an uplink channel corresponding to the first uplink transmission is a fifth PUCCH used to transmit the BFRQ information or a fifth PUSCH used to transmit the BFRQ information; and

an uplink channel corresponding to the second uplink transmission is a physical random access channel PRACH, or the information transmitted in the second uplink transmission is a sounding reference signal SRS.

Optionally, the receiving first uplink information sent by a terminal includes:

receiving information with a highest priority in the first uplink information.

Optionally, at least one of the first PUSCH, the second PUSCH, the third PUSCH, the fourth PUSCH, or the fifth PUSCH is a PUSCH in 2-step random access.

Optionally, an uplink channel corresponding to the first uplink transmission and an uplink channel corresponding to the second uplink transmission are respectively uplink channels of different cell groups.

The transceiver 902 or the processor 901 is configured to:

in a case of power sharing between cell groups, receive the uplink channel corresponding to the first uplink transmission and/or the uplink channel corresponding to the second uplink transmission, where

the terminal reduces, based on a priority of the first uplink information, transmit power of an uplink channel corresponding to information with a lower priority in the first uplink information.

Optionally, the BFRQ information includes at least one of a scheduling request SR used to indicate a beam failure event, new beam information, or index information of a cell in which a beam failure occurs.

In FIG. 9, a bus architecture may include any quantity of interconnected buses and bridges. Optionally, various circuits of one or more processors represented by the processor 901 and a memory represented by the memory 903 are interconnected. The bus architecture may further link various other circuits such as a peripheral device, a voltage regulator, and a power management circuit. These are well known in the art, and therefore are not further described in this specification. The bus interface provides an interface. The transceiver 902 may be a plurality of components. To be specific, the transceiver 902 includes a transmitter and a receiver, and provides a unit configured to communicate with various other apparatuses on a transmission medium. For different terminals, the user interface 904 may further be an interface that can be externally or internally connected to a required device, and the connected device includes but is not limited to a keypad, a display, a loudspeaker, a microphone, or a joystick.

The processor 901 is responsible for bus architecture management and general processing. The memory 903 may store data used by the processor 901 when the processor 901 performs an operation.

It should be noted that the network side device 900 in this embodiment may be a network side device in any implementation in the method embodiments in the embodiments of the present disclosure. Any implementation of the network side device in the method embodiments in the embodiments of the present disclosure may be implemented by the network side device 900 in this embodiment, and a same beneficial effect is achieved. To avoid repetition, details are not described herein again.

An embodiment of the present disclosure further provides a non-transitory computer-readable storage medium. The non-transitory computer-readable storage medium stores a computer program, and when the computer program is executed by a processor, the foregoing processes of the embodiment corresponding to the terminal or the network side are implemented and a same technical effect can be achieved. To avoid repetition, details are not described herein again. The non-transitory computer-readable storage medium includes a read-only memory (ROM), a random access memory (RAM), a magnetic disk, or an optical disc.

It should be noted that in this specification, the terms “comprise”, “include”, and any other variants thereof are intended to cover non-exclusive inclusion, so that a process, a method, an article, or an apparatus that includes a series of elements not only includes these very elements, but also includes other elements not expressly listed, or also includes elements inherent to this process, method, article, or apparatus. An element limited by “includes a . . . ” does not, without more constraints, preclude the presence of additional identical elements in the process, method, article, or apparatus that includes the element.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of the present disclosure essentially or the part contributing to the prior art may be implemented in a form of a software product. The computer software product is stored in a storage medium (such as a ROM/RAM, a hard disk, or an optical disc), and includes several instructions for instructing a terminal (which may be a mobile phone, a computer, a server, an air conditioner, a network device, or the like) to perform the methods described in the embodiments of the present disclosure.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. An uplink transmission method, comprising:
sending, by a terminal, second uplink information based on a priority of first uplink information in a case that a resource collision occurs between first uplink transmission and second uplink transmission, wherein
the first uplink information comprises information transmitted in the first uplink transmission and information transmitted in the second uplink transmission, the first uplink information comprises beam failure recovery request (BFRQ) information, and the second uplink information comprises a part or all of the first uplink information.

2. The method according to claim 1, wherein the sending, by the terminal, second uplink information based on a priority of first uplink information comprises at least one of:
sending, by the terminal, information with a highest priority in the first uplink information; or
sending, by the terminal, at least two pieces of information in the first uplink information through multiplexing in descending order of priorities.

3. The method according to claim 1, wherein the priority of the first uplink information is determined based on at least one of following priority relationships:
a priority relationship of each piece of information content in the first uplink information;
a priority relationship of a cell corresponding to each piece of information in the first uplink information; or
a priority relationship of an uplink channel corresponding to each piece of information in the first uplink information.

4. The method according to claim 3, wherein a priority of information corresponding to a primary cell is higher than a priority of information corresponding to a secondary cell in the first uplink information; and/or
a priority of information transmitted on an aperiodic uplink channel is higher than a priority of information transmitted on a periodic uplink channel in the first uplink information; and/or
the priority of the information transmitted on the aperiodic uplink channel is higher than a priority of information transmitted on a semi-persistent uplink channel in the first uplink information.

5. The method according to claim 3, wherein the first uplink information further comprises at least one of a scheduling request (SR), a hybrid automatic repeat request acknowledgement (HARQ-ACK), a channel state information (CSI) report, uplink data information, a sounding reference signal (SRS), or information transmitted on a physical random access channel (PRACH); and
the priority relationship of each piece of information content in the first uplink information comprises at least one of:
a priority of the BFRQ information is a highest priority;
the priority of the BFRQ information is higher than a priority of the HARQ-ACK;
the priority of the BFRQ information is higher than a priority of the SR;
the priority of the BFRQ information is higher than a priority of the CSI report;
the priority of the BFRQ information is higher than a priority of the SRS;
the priority of the BFRQ information is higher than a priority of the information transmitted on the PRACH;
the priority of the BFRQ information is higher than a priority of the uplink data information;
the priority of the BFRQ information is lower than the priority of the HARQ-ACK;
the priority of the BFRQ information is lower than the priority of the SR;
the priority of the BFRQ information is lower than the priority of the SRS; or
the priority of the BFRQ information is lower than the priority of the information transmitted on the PRACH.

6. The method according to claim 1, wherein an uplink channel corresponding to the first uplink transmission is a first physical uplink control channel (PUCCH) used to transmit the BFRQ information, and an uplink channel corresponding to the second uplink transmission is a second PUCCH used to transmit uplink control information (UCI); and
the sending, by the terminal, second uplink information based on a priority of first uplink information comprises:
sending, by the terminal, the BFRQ information and a part or all of the UCI by using the first PUCCH or the second PUCCH based on the priority of the first uplink information, wherein
the UCI comprises at least one of a scheduling request (SR), a hybrid automatic repeat request acknowledgement (HARQ-ACK), or a channel state information (CSI) report.

7. The method according to claim 6, wherein the UCI comprises the HARQ-ACK; and
the sending, by the terminal, second uplink information based on a priority of first uplink information comprises:
sending, by the terminal, the BFRQ information and the HARQ-ACK through multiplexing by using the first PUCCH or the second PUCCH in descending order of priorities.

8. The method according to claim 7, wherein the sending, by the terminal, the BFRQ information and the HARQ-ACK through multiplexing by using the first PUCCH or the second PUCCH comprises at least one of:
extending, by the terminal, a resource length of the first PUCCH, and sending the BFRQ information and the HARQ-ACK through multiplexing by using the first PUCCH;
extending, by the terminal, a resource length of the second PUCCH, and sending the BFRQ information and the HARQ-ACK through multiplexing by using the second PUCCH;
changing, by the terminal, a code rate of the BFRQ information and/or the HARQ-ACK, and sending the BFRQ information and the HARQ-ACK through multiplexing by using the first PUCCH;
changing, by the terminal, a code rate of the BFRQ information and/or the HARQ-ACK, and sending the BFRQ information and the HARQ-ACK through multiplexing by using the second PUCCH; or
sending, by the terminal, the BFRQ information and the HARQ-ACK through multiplexing by using a PUCCH that has a correspondence with a cell index in the first PUCCH and the second PUCCH.

9. The method according to claim 1, wherein an uplink channel corresponding to the first uplink transmission is a third physical uplink control channel (PUCCH) used to transmit the BFRQ information, and an uplink channel corresponding to the second uplink transmission comprises N first physical uplink shared channels (PUSCHs), wherein N is an integer greater than or equal to 1.

10. The method according to claim 9, wherein the sending, by the terminal, second uplink information based on a priority of first uplink information comprises at least one of:
sending, by the terminal, the second uplink information by using the N first PUSCHs based on the priority of the first uplink information, wherein N is equal to 1; or
sending, by the terminal, the second uplink information by using a PUSCH corresponding to a lowest cell index or a highest cell index in the N first PUSCHs based on the priority of the first uplink information, wherein N is an integer greater than 1.

11. The method according to claim 1, wherein an uplink channel corresponding to the first uplink transmission is a second physical uplink shared channel (PUSCH) used to transmit the BFRQ information, and an uplink channel corresponding to the second uplink transmission comprises M third PUSCHs, wherein M is an integer greater than or equal to 1.

12. The method according to claim 11, wherein the sending, by the terminal, second uplink information based on a priority of first uplink information comprises at least one of:
sending, by the terminal, the second uplink information by using a PUSCH corresponding to a lowest cell index or a highest cell index in the second PUSCH and the M third PUSCHs based on the priority of the first uplink information, wherein M is an integer greater than or equal to 1;
sending, by the terminal, the second uplink information by using the second PUSCH based on the priority of the first uplink information;
sending, by the terminal, the second uplink information by using the M third PUSCHs based on the priority of the first uplink information, wherein M is equal to 1; or
sending, by the terminal, the second uplink information by using a PUSCH corresponding to a lowest cell index or a highest cell index in the M third PUSCHs based on the priority of the first uplink information, wherein M is an integer greater than 1.

13. The method according to claim 1, wherein an uplink channel corresponding to the first uplink transmission is a fourth physical uplink shared channel (PUSCH) used to transmit the BFRQ information, and an uplink channel corresponding to the second uplink transmission is a fourth physical uplink control channel (PUCCH).

14. The method according to claim 13, wherein the sending, by the terminal, second uplink information based on a priority of first uplink information comprises at least one of:
sending, by the terminal, the second uplink information by using the fourth PUSCH based on the priority of the first uplink information; or
sending, by the terminal, the second uplink information by using the fourth PUCCH based on the priority of the first uplink information.

15. The method according to claim 1, wherein an uplink channel corresponding to the first uplink transmission is a fifth physical uplink control channel (PUCCH) used to transmit the BFRQ information or a fifth physical uplink shared channel (PUSCH) used to transmit the BFRQ information; and
an uplink channel corresponding to the second uplink transmission is a physical random access channel (PRACH), or the information transmitted in the second uplink transmission is a sounding reference signal (SRS).

16. The method according to claim 15, wherein the sending, by the terminal, second uplink information based on a priority of first uplink information comprises:
sending, by the terminal, information with a highest priority in the first uplink information.

17. The method according to claim 1, wherein an uplink channel corresponding to the first uplink transmission and an uplink channel corresponding to the second uplink transmission are respectively uplink channels of different cell groups; and
the method further comprises:
in a case of power sharing between cell groups, reducing, by the terminal, based on the priority of the first uplink information, transmit power of an uplink channel corresponding to information with a lower priority in the first uplink information.

18. The method according to claim 1, wherein the BFRQ information comprises at least one of a scheduling request (SR) used to indicate a beam failure event, new beam information, or index information of a cell in which a beam failure occurs.

19. A terminal, comprising a memory, a processor, and a computer program that is stored in the memory and executable on the processor, wherein the computer program, when executed by the processor, causes the terminal to perform:
sending second uplink information based on a priority of first uplink information in a case that a resource collision occurs between first uplink transmission and second uplink transmission, wherein
the first uplink information comprises information transmitted in the first uplink transmission and information transmitted in the second uplink transmission, the first uplink information comprises beam failure recovery request (BFRQ) information, and the second uplink information comprises a part or all of the first uplink information.

20. A network side device, comprising a memory, a processor, and a computer program that is stored in the memory and executable on the processor, wherein the computer program, when executed by the processor, causes the network side device to perform:
receiving first uplink information sent by a terminal, wherein the first uplink information is information sent by the terminal based on a priority of second uplink information in a case that a resource collision occurs between first uplink transmission and second uplink transmission, the first uplink information comprises a part or all of the second uplink information, the second uplink information comprises information transmitted in the first uplink transmission and information transmitted in the second uplink transmission, and the second uplink information comprises beam failure recovery request (BFRQ) information; and
determining information content of the first uplink information based on the priority of the second uplink information.
